(19) United States
(12) Patent Application Publication
(10) Pub. No.: US 2005/0197903 A1
(43) Pub. Date: Sep. 8, 2005

(54) Interactive electronic-desktop alert and compliance tool

(75) Inventors: Daniel Hoffman, Long Valley, NJ (US); Michael Sutch, Flemington, NJ (US); Jamie O'Keefe, Bloomfield, NJ (US); William C. Rehm, Lebanon, NJ (US)

Correspondence Address: SYNNESTVEDT & LECHNER, LLP, 2600 ARAMARK TOWER, 1101 MARKET STREET, PHILADELPHIA, PA, 191072950, US

(73) Assignee: Aventis Pharmaceuticals Inc., Bridgewater, NJ (US)

(21) Appl. No.: 11/031,766

(22) Filed: Jan. 7, 2005

Related U.S. Application Data
(60) Provisional application No. 60/535,623, filed on Jan. 9, 2004.

(51) Int. Cl. G06F 17/60

(52) U.S. Cl. 705/14

(57) ABSTRACT

The present invention improves upon tools of the prior art by enabling a user of such a tool to have alerts sent to an electronic “desktop” of multiple devices, such as a computer screen, the display of a Personal Digital Assistant (PDA) or cell phone, pagers and the like. Further, in accordance with the present invention, the user of the tool is solicited to provide information back to the tool. This interactive aspect can take on many forms and can be used for marketing and or and/or medical research, and can also be used to give the user positive reinforcement for compliant behavior; for example, when the user takes the appropriate dosage of a medication at the appropriate time, the tool's graphics could respond by displaying a positive graphic such as a smiling face. Failure to properly follow a medication regimen could result in the display of a negative graphic, such as a said face.

### CROSS-REFERENCE TO RELATED APPLICATIONS

This application is based on and claims priority to U.S. Provisional Application No. 60/535,623, filed Jan. 9, 2004, whose contents is incorporated fully herein by reference.

### BACKGROUND OF THE INVENTION

Patients typically use pharmaceutical products in the home, which is an environment that is isolated from information and/or people (e.g., nurses, doctors, etc.) that could help to improve outcomes resulting from use of the pharmaceutical product and increase compliance with the prescribed use. Improved outcomes and increased compliance can improve the health of the patient; from the point of view of a pharmaceutical company, improved outcomes and increased compliance can increase the relative value of the product and substantially improve revenues.

Computers are becoming increasingly useful as marketing tools. By providing software tools that reside on a personal computer, companies are able to market products to consumers by providing them with useful information interleaved with marketing messages. A typical example of one such tool is “Weatherbug”, available for download at www.weatherbug.com. A person using the Weatherbug program receives up to the minute information regarding weather conditions in their area, based upon a zip code input by the user. The user receives frequent weather updates, weather alerts, and other weather related information, while simultaneously receiving fixed or streaming marketing materials on their computer screen.

This type of marketing strategy is currently being used in the pharmaceutical field. A visit to www.Benadryl.com gives a computer user the ability to download an “allergy alert tool” that allows the user to track allergy levels based on input of a zip code. The information is updated periodically so that changes in allergy levels are noted. If desired, the user may select an option which enables the tool to send an alert to the computer screen of the user when a high pollen level exists. Other information is also available, for example, five day weather forecasts. Pfizer, the company that makes Benadryl and who supplies the tool for download also provides a user with a constant stream of marketing information and images that serve to keep the product, Benadryl, in the mind of the consumer on a regular basis.

### SUMMARY OF THE INVENTION

The present invention improves upon tools of the prior art by enabling a user of such a tool to have alerts sent to an electronic “desktop” of multiple devices, such as a computer screen, the display of a Personal Digital Assistant (PDA) or cell phone, pagers and the like. Further, in accordance with the present invention, the user of the tool is solicited to provide information back to the tool. This interactive aspect can take on many forms and can be used for marketing and or and/or medical research, and can also be used to give the user positive reinforcement for compliant behavior; for example, when the user takes the appropriate dosage of a medication at the appropriate time, the tool's graphics could respond by displaying a positive graphic such as a smiling face. Failure to properly follow a medication regimen could result in the display of a negative graphic, such as a sad face.

### BRIEF DESCRIPTION OF THE DRAWINGS

FIG. 1 illustrates an example of the substance of a display generated on a user's machine when using the present invention;

FIG. 2 illustrates the basic architecture of the present invention;

FIG. 3 is a flowchart illustrating the basic steps performed by users to configure the present invention for use;

FIG. 4 illustrates an example of a screen that might be presented to a user as part of steps 306 and 308 of FIG. 3; and

FIG. 5 is a flowchart illustrating the operation of the present invention.

### DETAILED DESCRIPTION OF THE PREFERRED EMBODIMENTS

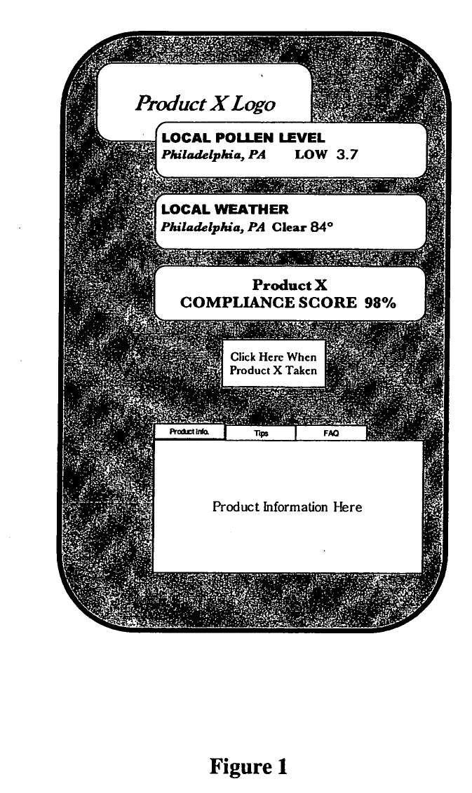

FIG. 1 illustrates an example of the substantive aspects of a display generated on a user's machine when using the present invention. The form of the display can change in numerous ways, as will be appreciated. For example, different colors, fonts, shapes, animations and the like can all be used to display the substance of FIG. 1 in different manners. Further, although particular substantive aspects are illustrated in FIG. 1, numerous other modifications in terms of substance will be apparent and are included in the disclosure and claims herein.

Referring to FIG. 1, an interactive desktop tool 100 in accordance with the present invention is displayable on a user desktop, preferably as a layer or window over an existing window in a graphic user interface (GUI). A product logo area 102 is allocated so that the user immediately receives marketing messages relating to the product. Obviously more than one logo can be shown, or multiple tools 100 can be displayed, one for each product, if desired. In the example of FIG. 1, a Local Pollen Level is displayed in area 104, and Local Weather is displayed in area 106. The determination of what is “local” is made during the configuration process, discussed below, whereby the user inputs a zip code or city name to identify the locality. Thus, in accordance with the present invention, “primary content”, that is, content directly related to a product being marketed, such as information regarding pharmaceutical products, can be delivered to the user, as well as “secondary content”, that is, content that is either indirectly related or unrelated to the pharmaceutical product, can also be delivered. Examples of primary content include chemical and generic names of the pharmaceuticals, dosage and directions information, information on side effects, and the like. Examples of secondary content include environment information (e.g., weather, pollen count, etc.), general health and fitness information, dietary information, and the like.

The above-described information provides information to the user from the party providing the tool to users. However, in addition to pushing information to users, the present invention also has an interactive aspect, whereby information is “pulled” from the users. Referring to FIG. 1, area 110 requests the user to click a GUI button whenever product X has been taken. In other words, the user submits to the provider information regarding, in this case, use of the product being marketed by the marketing tool. As a result of input from the user, a compliance indicator can be displayed to the user, e.g., a compliance score can be calculated and provided and displayed to the user, in this example, in area 108.

In accordance with the present invention, the display of the compliance indicator can take many different variations. In the example of FIG. 1, a simple percentage of compliance is illustrated. However, for younger users and/or for those who prefer a more whimsical or amusing way of displaying compliance, area 108 could be replaced by graphical images showing compliance, e.g., race cars racing around a track; a character showing indications of good or bad health depending upon the level of compliance; a smiling face or a sad face, etc. Such images can be an incentive to the user to comply with the drug regimen, particularly in children and young adults.

Area 112 in FIG. 1 illustrates an informational area where users can click on and display product information, tips, frequently asked questions, etc. in a well-known manner.

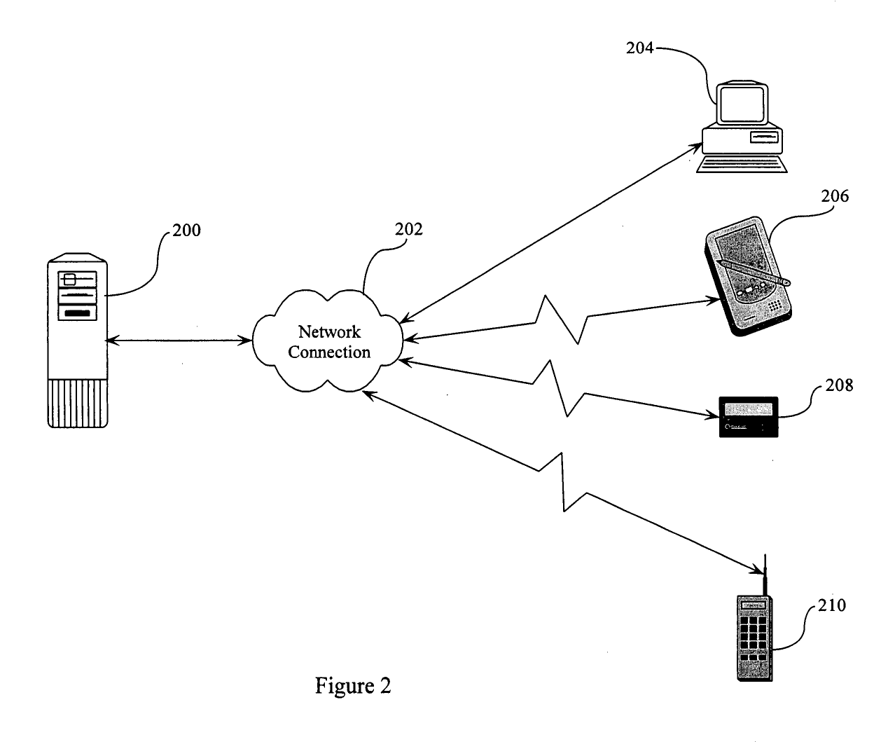

FIG. 2 illustrates the basic architecture of the present invention. As shown in FIG. 2, a server 200 maintained by the provider is connectable to multiple user devices, e.g., a desktop PC 204, a PDA 206, a pager 208, and/or a cell phone 210 via a network connection 202.

Network connection 202 can comprise any means of network connection, including a hard-wired connection, landline telephone connection, wireless connection, or any other means of providing connectability to the various user devices 204-210.

Server 200 includes storage capability for storing the marketing and other information to be pushed to the users. The stored information will include configuration information, data to be pushed to the users (e.g., allergy information, weather information, etc.), and program for processing configuration information and other information input by the users. Server 200 also includes the ability to perform messaging, that is, to deliver, in proper format, alerts as per configurations by the user, e.g., to send “take meds” messages to the user's cell phone and pollen count to the user's email address. It is understood that while FIG. 2 illustrates server 200 as an individual server, multiple servers, storage devices, messaging servers, and the like can be used instead of a single server performing all of these functions.

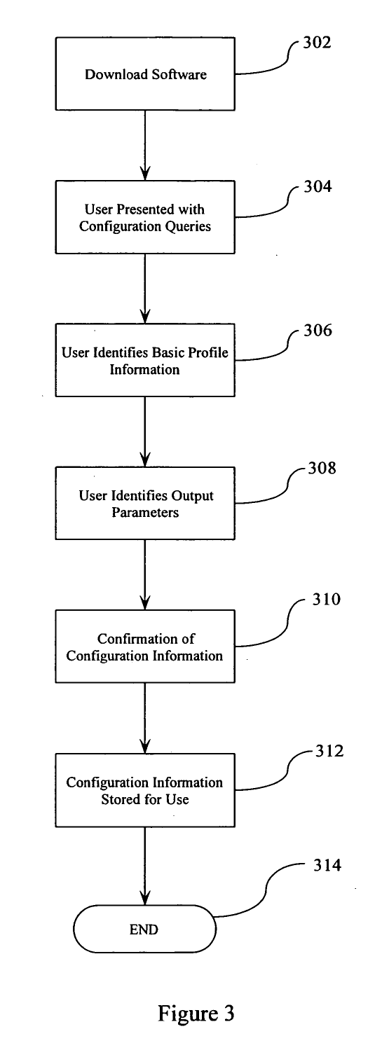

FIG. 3 is a flowchart illustrating the basic steps performed by users to configure the present invention for use. At step 302, the user downloads software to any of the user devices on which the present invention will be utilized. At step 304, the user is presented with configuration queries. These are simply a series of questions, forms, etc. that the user will use to provide input information.

At step 306, the user identifies basic profile information based on the configuration queries. For example, the user will be asked to input name, address, telephone number, as well as demographic data. The user may also be asked questions about what medications they take, what medical conditions they currently have.

At step 308, the user determines which parameters should be output to their various devices. For example, the user can request that weather information always be displayed on their PC along with pollen information, and request that alerts be sent to a pager and that pollen counts be emailed daily to a PDA or cell phone. Step 308 is essentially a set-up step which allows the user to identify what will be delivered to them from the provider and when and how.

At step 310, a summary screen is displayed to the user listing a summary of the configuration information input by the user and giving them an opportunity to correct any inaccuracies. Obviously this step is optional, but including it will result in more accurate information being stored.

At step 312, the configuration information is stored for use, preferably in the server 200, and at step 314 the process ends.

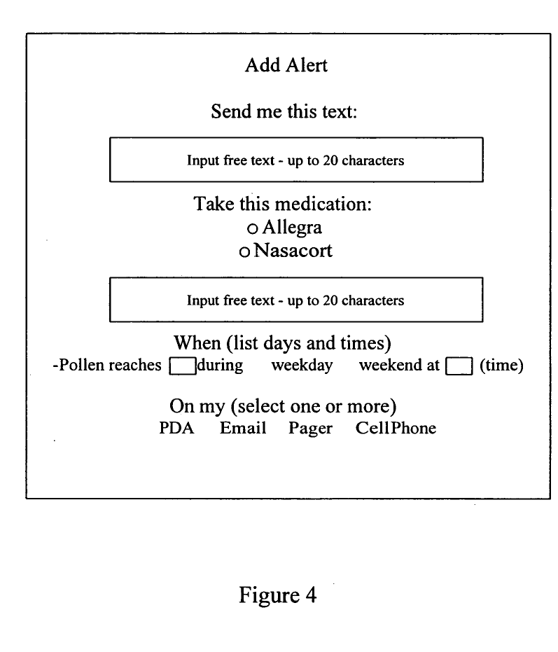

FIG. 4 illustrates an example of a screen that might be presented to a user as part of steps 306 and 308 of FIG. 3. As can be seen in FIG. 4, the user is given the option of adding alerts, which means the user will be alerted when particular conditions arise as selected from the selection screen of FIG. 4. Specifically, the user is instructed to input free text if desired (e.g., the user might input “POLLEN ALERT!!”); then the user will be requested to select one or more medications to take and is given additional free text input capability (e.g., to write dosage amounts, for example); then the user is given the option of indicating when the alert should occur, both (in this example) based on pollen level and the day of the week and the time, and the user is also given the option of where to have the alerts sent, based on checking off one or more of the end user options to which they have access (PDA, email, pager, cell phone). It is understood that FIG. 4 is simply an example of how this kind of information might be solicited and it is not intended to limit the invention to the exact configuration of FIG. 4. Similar screens would be provided to allow the user to select what materials to be shown (e.g., weather, pollen count, etc.).

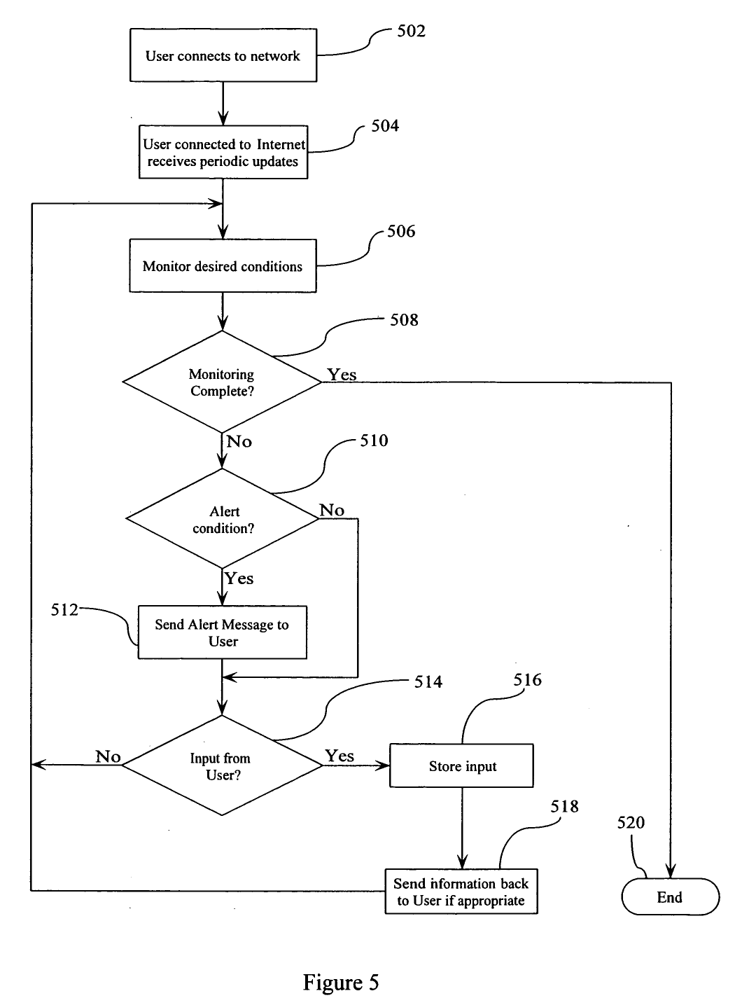

FIG. 5 is a flowchart illustrating the operation of the present invention. At step 502, the user connects to the network. Typically this will be done via the user's PC and the tool of the present invention will automatically be displayed on the user's screen. Alternatively, of course, the user could click an icon to launch the tool. At step 504, if the user is connected to the Internet, they will begin to receive periodic updates from the launched tool. At step 506, the desired conditions, as set forth in the user's configuration set-up, are monitored. This monitoring can take place at any desired interval, e.g., every minute, every second, every hour, every day, depending upon the user's desires and the hardware configuration being used. For example, a dial-up connection to the Internet might not adequately support a refresh interval of once-a-second.

At step 508, a determination is made as to whether or not the monitoring process is complete. Typically, the monitoring process would only be complete when the user determines that they no longer wish to monitor the desired conditions or they shut down the system on which the tool is running. If a determination is made that monitoring is complete at step 508, the process proceeds to step 520 and the process ends.

However, if at step 508, a determination is made that the monitoring process is not complete, then at step 510, a determination is made as to whether or not any alert conditions have been met. These are the alert conditions either preset by the provider or set by the user during the configuration set-up process. For example, if the user requests to be alerted when the pollen count reaches a certain level, and then the pollen count reaches that level, this would be considered an alert condition existing, resulting in a “yes” response from the query box 510. If at step 510 it is determined that there are alert conditions met, then at step 512, an alert message is sent to the user in accordance with the method or methods prescribed in the user's configuration setup. If at step 510 it is determined that no alert conditions currently exist, then the process bypasses step 512, and proceeds to step 514.

At step 514 a determination is made as to whether or not there has been any input from the user. Input from the user would be, for example, an indication that a particular dose of medicine was taken at a particular time, or a request to refresh the monitored conditions. Numerous other examples of input from the user will be apparent to a designer or user of the present invention and all such examples are considered to be covered by the appended claims.

If at step 514 it is determined that input from the user has been received, then the process proceeds to step 516, where the input is stored, preferably in server 200, and then at step 518, any appropriate information resulting from the user input is sent back to the user. For example, if the user has requested updated pollen counts, then these pollen counts are submitted. Further, if the user has requested a change in the zip code for the locality, then new data representative of the zip code input is provided back to the user at step 518. The process then loops back to step 506 for monitoring of the desired conditions. Similarly, if at step 514, it is determined that there has been no input from the user, the process proceeds back to step 506 where the desired conditions are monitored.

Using the above-described invention, users are provided with current data regarding particular conditions, typically environmental conditions, and are given incentives to be compliant with a pharmaceutical regimen related to the monitored conditions. The user is able to input information regarding compliance (or other parameters) back to the provider and obtain results (in the form of new information, incentive displays, and the like) from the provider. Further, the user has multiple options for receiving data from the provider and submitting data to the provider, each of which are selectable by the user, so that regardless of the user location, they are always in contact with the provider and are able to receive the requested information.

The actual data monitored and provided to the user can be maintained by the organization responsible for updating the information displayed on the tool. This is performed in a well-known manner, such as the same manner used by “weatherbug.com”.

The above-described steps can be implemented using standard well-known programming techniques. Software programming code which embodies the present invention is typically stored in permanent storage of some type, such as permanent storage of server 200, a memory location of a PDA, desktop computer, or cell phone of a user of the system. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein. It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method of disseminating primary content and secondary content to a user, comprising the steps of:
setting content-delivery preferences for said user, said content-delivery preferences including identification of at least two devices to which said content will be delivered;
delivering primary content and secondary content to said user using said content-delivery preferences; and
providing said user with incentives to view said delivered content on a regular basis.

2. The method of claim 1, wherein said primary content comprises information regarding pharmaceutical products.

3. The method of claim 2, wherein said information regarding pharmaceutical products includes dosage, information specific to said user for one or more of said pharmaceutical products.

4. The method of claim 3, further comprising the steps of:
soliciting input from said user regarding compliance with said dosing information; and
displaying a compliance indicator to the user based upon submitted compliance information.

5. The method of claim 4, wherein said compliance indicator comprises a compliance score, calculated based upon the user's compliance information.

6. The method of claim 4, wherein said compliance indicator comprises a graphical image displaying a non-numerical indication of compliance.

7. The method of claim 2, wherein said secondary information comprises information regarding environmental parameters.

8. The method of claim 7, wherein said environmental parameters include pollen level information.

9. The method of claim 8, wherein said pollen level information is provided on a local basis.

10. The method of claim 8, wherein said pollen level information is provided on a regional basis.

11. The method of claim 8, wherein said environment information comprises local weather information.

12. A system of disseminating primary content and secondary content to a user, comprising:
means for setting content-delivery preferences for said user, said content-delivery preferences including identification of at least two devices to which said content will be delivered;
means for delivering primary content and secondary content to said user using said content-delivery preferences; and
means for providing said user with incentives to view said delivered content on a regular basis.

13. The system of claim 12, wherein said primary content comprises information regarding pharmaceutical products.

14. The system of claim 13, wherein said secondary information comprises information regarding environmental parameters.

15. The system of claim 14, wherein said environmental parameters include pollen level information.

16. A computer program product for disseminating primary content and secondary content to a user, the computer program product comprising a computer-readable storage medium having computer-readable program code embodied in the medium, the computer-readable program code comprising:
computer-readable program code that sets content-delivery preferences for said user, said content-delivery preferences including identification of at least two devices to which said content will be delivered;
computer-readable program code that delivers primary content and secondary content to said user using said content-delivery preferences; and
computer-readable program code that provides said user with incentives to view said delivered content on a regular basis.

17. The computer program product of claim 16, wherein said primary content comprises information regarding pharmaceutical products.

18. The computer program product of claim 17, wherein said secondary information comprises information regarding environmental parameters.

19. The computer program product of claim 18, wherein said environmental parameters include pollen level information.

20. The computer program product of claim 19, wherein said pollen level information is provided on a local basis.
